(19) United States
(12) Patent Application Publication
(10) Pub. No.: US 2022/0169814 A1
(43) Pub. Date: Jun. 2, 2022

(54) Foamable Silicone Composition, Preparation Method and Use Thereof

(71) Applicant: Henkel AG & Co. KGaA, Duesseldorf (DE)

(72) Inventors: Xiaomeng Wu, Shanghai (CN); Bingbing Guo, Shanghai (CN); Dongmei Shen, Shanghai (CN)

(21) Appl. No.: 17/676,064

(22) Filed: Feb. 18, 2022

Related U.S. Application Data
(63) Continuation of application No. PCT/CN2019/102477, filed on Aug. 26, 2019.

(51) Int. Cl. C08J 9/02; C08G 77/12; C08J 9/00; C08G 77/16; C08G 77/20; C08J 9/14

(52) U.S. Cl. CPC C08J 9/02; C08G 77/12; C08J 9/0066; C08G 77/16; C08J 2383/07; C08J 9/142; C08J 2201/022; C08J 2207/02; C08G 77/20

(57) ABSTRACT

The present invention provides a two-component foamable silicone composition comprising: a component A comprising (a) at least one polyorganosiloxane having at least one vinyl group, (b) at least one chemical blowing agent, and (c) at least one catalyst; and a component B comprising (d) at least one polyorganosiloxane having at least one vinyl group, and (e) at least one polyorganosiloxane having at least one —SiH group, and at least one expandable graphite in an amount of less than 10% by weight, based on the total weight of the component B, which exhibits excellent flame retardancy, good sealing performance, high compression rate, low gasket density, good dispensing continuity and good cell structure. The present invention also provides a preparing method and use thereof.

### TECHNICAL FIELD

The present invention relates to a foamable silicone composition, and particularly relates to a flame-retardant silicone foam, the preparation method and use thereof.

### BACKGROUND OF THE INVENTION

A technology which has become established for many decades is that of applying foaming and nonfoaming materials in liquid form directly to parts, where they react chemically and form a suitable sealing element. This technology is often referred to as “FIPG” (Formed in Place Gasket) or “FIPFG” (Formed in Place Foam Gasket) to represent a sealant attached by foaming to a part in situ, which has been widely used in various applications, such as automotive, cabinet, lamps, packaging and customary housing in recent years.

The use of silicone foam as a sealant is known in the art. Silicone foams can be provided by numerous suppliers for a variety of applications. Examples of companies offering such products include Sonderhoff, Wacker (Elastosil silicone rubber) or Dow Chemical. Corresponding foams are described for example in EP 0 691 365 A1 and WO 00/46282 A1.

Generally, silicone foam gaskets are formed from a foaming/curing organopolysiloxane composition. Organopolysiloxane compositions are cured while simultaneously foaming. These types of organopolysiloxane compositions are typically divided into two components for storage, which occurs foaming/curing reaction when two components are mixed to prepare silicone foam.

Due to increasingly diverse application of silicone foam gasket, it has been expected to offer more properties, such as flame retardancy. Many automotive industry manufacturers require that the materials must meet the Level V0 of UL94 test. Various methods for preparing flame-retardant polyorganosiloxane foams have been described in the art.

U.S. Pat. No. 3,425,967 to Modic discloses mixtures containing asbestos and fibrous potassium titanite as flame retarding additives for polyorganosiloxane foams.

U.S. Pat. No. 4,026,842 to Lee et al. and U.S. Pat. No. 3,923,705 to Smith disclose to use platinum or a platinum compound to improve flame retardancy of polyorganosiloxane foams prepared by reacting organohydrogen siloxanes and siloxanes containing silicon-bonded hydroxyl groups. Smith teaches that flame retardancy can be further improved by carbon black.

U.S. Pat. No. 4,433,069 to Harper et al. teaches fire resistant polysiloxane foams having a combination of at least 0.1% each of a nonmetallic fibrous heat resistant material, at least one finely divided nonmetallic cellular heat resistant material, and at least 5 ppm platinum. The fibrous heat resistant materials include naturally occurring materials, such as asbestos, man-made fibers and whiskers formed from glass, carbon, alumina, inorganic silicates such as aluminum silicate and mixtures of aluminum silicate with alkali metal and/or alkaline earth metal silicates. Preferred fibrous heat resistant materials are glass and carbon.

However, most of commercial products containing flame-retardant additives on the market cannot pass Level V0 of the flame-retardancy test of UL94. Even if those products can pass Level V0 of UL94 test, they have poor dispensing continuity or poor cell structure or cannot meet requirement of compression rate and sealing performance simultaneously. This is because that adding flame-retardant additives influences the reaction rate and hence produces too much heat during the reaction process. Therefore, it cannot be cured and foamed properly. Other disadvantage includes poor appearance of the sealant product, as large particles of the flame-retardant additives are attached to the sealant product.

Therefore, it needs to improve the flame retardancy of the foamable silicone composition to pass Level V0 of UL94 test and in the meantime to render the foam to have low density, high compression rate, good sealing performance, and good dispensing continuity.

### SUMMARY OF THE INVENTION

The object of the present invention is to provide a two-component foamable silicone composition having some or all of the following: excellent flame retardancy, good sealing performance, high compression rate and low gasket density, and good dispensing continuity.

After intensive studies, the inventors have found that the above problems can be solved by a two-component foamable silicone composition comprising:

a component A comprising
(a) at least one polyorganosiloxane having at least one vinyl group,
(b) at least one chemical blowing agent, and
(c) at least one catalyst; and
   a component B comprising
(d) at least one polyorganosiloxane having at least one vinyl group,
(e) at least one polyorganosiloxane having at least one —SiH group, and
(f) at least one expandable graphite in an amount of less than 10% by weight, based on the total weight of the component B.

The advantages of the foamable silicone composition described herein are that the composition renders the materials to have excellent flame retardancy, good sealing performance and low gasket density. In addition, it can be dispensed with high continuity for increasing productivity efficiency and reducing waste to ensure the sealing performance. According to the present invention, the ratio of polyorganosiloxane with reactive groups can be modified to ensure a good dispensing continuity, low density and flame-retardant property. Further still, the silicone foam described herein also provides high compression rate to guarantee the sealing performance, rapid curing and foaming at room temperature and short assembly time as well as excellent anti-aging performance. For example, the foamable silicone composition can be cured at room temperature for 24 hours or after heating to around 60° C. for 2 hours.

### BRIEF DESCRIPTION OF THE FIGURES

FIG. 1 is the optical microscope photograph with the magnification ratio of 5× of cell structure of silicone foam according to Example 3.

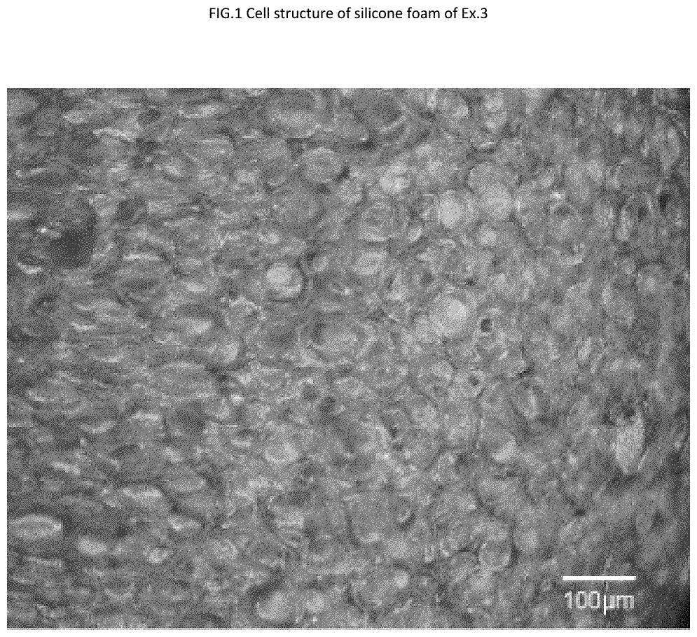

FIG. 2 is the optical microscope photograph with the magnification ratio of 10× of cell structure of silicone foam according to Example 5.

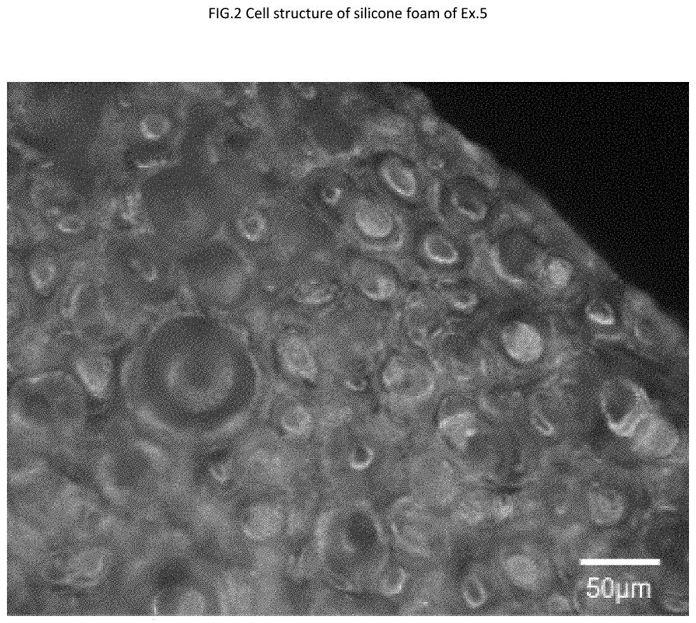

FIG. 3 is the optical microscope photograph with the magnification ratio of 5× of cell structure of silicone foam according to Comparative Example 6.

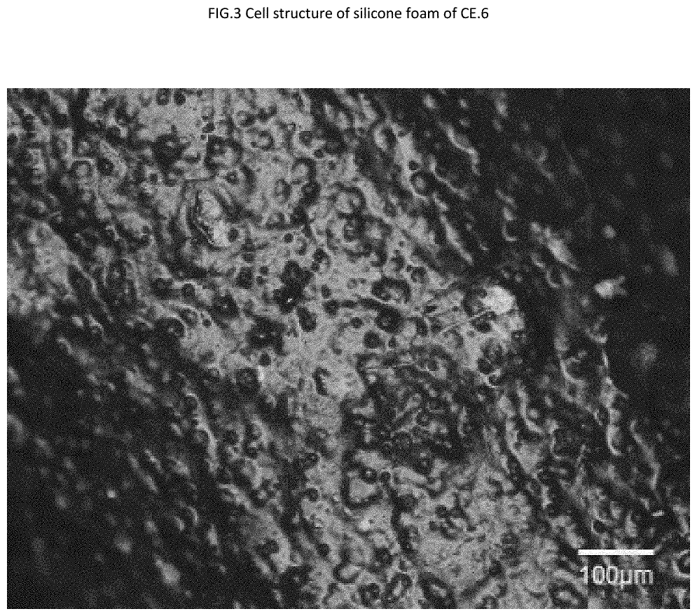

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

Unless specified otherwise, the recitation of numerical end points includes all numbers and fractions subsumed within the respective ranges, as well as the recited end points.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

Unless specified otherwise, the term “two-component” refers to a composition comprising or consisting of two components that are stored in separate containers because of their mutual reactivity. The two components are generally not mixed until shortly before application of the composition to a substrate. When the two separate components are mixed, the mutually reactive compounds in the two components react to crosslink and form a cured reaction product.

According to the present invention, a two-component foamable silicone composition comprises:

a component A comprising
(a) at least one polyorganosiloxane having at least one vinyl group,
(b) at least one chemical blowing agent, and
(c) at least one catalyst; and
   a component B comprising
(d) at least one polyorganosiloxane having at least one vinyl group,
(e) at least one polyorganosiloxane having at least one —SiH group, and
(f) at least one expandable graphite in an amount of less than 10% by weight, based on the total weight of the component B.

### (a) Polyorganosiloxane Having at Least One Vinyl Group

The component A comprises at least one polyorganosiloxane having at least one vinyl group.

Preferably, the component A can comprise at least two polyorganosiloxanes having at least one vinyl group in one molecule, preferably a mixture of at least one linear polyorganosiloxane having at least one vinyl group and at least one branched polyorganosiloxane having at least one vinyl group in one molecule, more preferably a vinyl functional MQ polyorganosiloxane.

Preferably, the polyorganosiloxane having at least one vinyl group is a polydiorganosiloxane, more preferably a polydimethylsiloxane, having at least one, preferably at least two vinyl groups per molecule, more preferably at least two terminal vinyl groups per molecule.

The skilled person is aware that in the case of polymers, functionalization, or end-group functionalization with, for example, vinyl groups, does not always proceed to completion, with the consequence that even after functionalization has been carried out, there are polymers remaining which are unfunctionalized, only singly functionalized, or more than doubly functionalized. The expression “at least one vinyl group (in one molecule)” therefore means that in the case of the constituent employed, the individual polymer molecules are functionalized on average, over all the polymer molecules of the same type, with at least one vinyl group.

In preferred embodiments, the polyorganosiloxane having at least one vinyl group in the two-component foamable silicone composition is QM-resin, vinyl-terminated polyorganosiloxane, and a mixture thereof. The vinyl-terminated polyorganosiloxane can have one terminated vinyl group, preferably have two terminated vinyl groups.

In preferred embodiments, the vinyl-terminated polyorganosiloxane can be a mixture comprising at least one vinyl-terminated polyorganosiloxane having viscosity of lower than 20,000 cps at 20° C. and at least one vinyl-terminated polyorganosiloxane having viscosity of from 20,000 to 80,000 cps at 20° C.; more preferably a mixture of at least one vinyl-terminated polyorganosiloxane having viscosity of lower than 10,000 cps at 20° C. and at least one vinyl-terminated polyorganosiloxane having viscosity of from 30,000 to 70,000 cps at 20° C. The vinyl-substitution can range from about 0.0001% to 3% by weight, and preferably from about 0.001% to about 1% by weight, based on the weight of the polyorganosiloxane having at least one vinyl group in the component A.

The vinyl functional groups can be introduced in the polyorganosiloxane via various reactions.

It is possible to use commercially available products in the present invention. Examples thereof include Genesee MSR 8001-1H available from Genesee Advanced Materials Nantong Co., Ltd.

With particular preference, the polyorganosiloxane having at least one vinyl group may be incorporated into the foamable silicone composition in an amount of from 50% to 79.9% by weight, preferably from 60% to 69.5% by weight, such as 60%, 63%, 65%, 68% by weight, based on the total weight of the component A.

### (b) Chemical Blowing Agent

The component A comprises at least one chemical blowing agent.

Preferably, the chemical blowing agent can be a compound having at least one hydroxyl group, including one, two or more hydroxyl groups, or is a mixture of compounds having at least one hydroxyl group. In preferred embodiments, the chemical blowing agent is selected from water, alcohols, polyorganosiloxanes having at least one hydroxyl group, and a mixture thereof. Examples of the alcohols are such as methanol, ethanol, propanol, isopropanol, and butanol. The hydroxyl group of the chemical blowing agent can react with the silicon-hydrogen group of the polyorganosiloxane having at least one —SiH group (hydrosilyl group) in the component B to produce hydrogen gas and hence create the cells in the foam.

In preferred embodiments, the chemical blowing agent can be a polydiorganosiloxane, preferably polydimethylsiloxane, having at least one, preferably at least two hydroxyl groups, more preferably two terminal hydroxyl groups. The viscosity of the polyorganosiloxanes having at least one hydroxyl group can range from 500 to 6000 cps at 25° C.

In preferred embodiments, the chemical blowing agent can be a mixture comprising hydroxyl-terminated polydimethylsiloxane having viscosity, at 20° C., of from 70 to 500 cps and/or hydroxyl-terminated polydimethylsiloxane having viscosity, at 20° C., of from 750 to 1000 cps and/or hydroxyl-terminated polydimethylsiloxane having viscosity, at 20° C., of 4000 to 5000 cps. The hydroxyl terminated polydimethylsiloxane having a lower viscosity can be equipped with more numbers of effective crosslinking per unit volume thereby react much more quickly than those polydimethylsiloxanes having a higher viscosity.

Preferably, the hydroxyl terminated polydimethylsiloxanes having viscosity at 20° C., of from 70 to 500 cps can be in an amount of from 30% to 50% by weight; the hydroxyl terminated polydimethylsiloxanes having viscosity at 20° C., of from 750 to 1000 cps is in an amount of from 30% to 50% by weight; and the hydroxyl terminated polydimethylsiloxanes having viscosity at 20° C., of from 4000 to 5000 cps is in an amount of from 10% to 30% by weight, each based on the total weight of the hydroxyl terminated polydimethylsiloxanes, which may achieve preferable curing and foaming rate, and therefore may give excellent cell structure.

In preferred embodiments, the chemical blowing agent can be hydroxyl-terminated polydimethylsiloxane(s), preferably a mixture comprising hydroxyl-terminated polydimethylsiloxanes having a —OH content of from 0.5 to 1.0 mmol/g, and/or from 0.1 to 0.5 mmol/g and/or from 0.01 to 0.1 mmol/g.

It is possible to use commercially available products in the present invention. Examples thereof include Andisil® OH Polymer with various viscosities and silanol contents, from 70 to 4000 cps available from AB Specialty Silicones, LLC.

With particular preference, the chemical blowing agent may be incorporated into the foamable silicone composition in an amount of from 20% to 49.5% by weight, preferably in an amount of from 30% to 39.5%, such as 30%, 34%, 38%, 39% by weight, based on the total amount of the component A.

### (c) Catalyst

The component A comprises at least one catalyst.

Preferably, the catalyst can be selected from the group consisting of platinum, palladium, rhodium, nickel, iridium, ruthenium catalysts, and mixtures thereof, preferably platinum catalyst, which can efficiently promote the reaction of —SiH groups with vinyl groups and the reaction between —SiH groups and hydroxyl groups to provide hydrogen gas for the foaming process.

Particularly preferred is a two-component foamable silicone composition wherein the catalyst is an organoplatinum compound.

Particularly preferred is a two-component foamable silicone composition wherein the catalyst is functional organoplatinum compound selected from an (η-diolefin) (α-aryl) platinum complex, an (η-diolefin) (γ-aryl)-platinum complex, an (η-diolefin) (γ-alkyl)-platinum complex, and mixtures thereof.

It is possible to use commercially available products in the present invention. Examples thereof include Catalyst 510, 540 available from Evonik Specialty Chemicals (Shanghai).

With particular preference, the catalyst may be incorporated into the foamable silicone composition in an amount of from 0.1 to 0.5% by weight, preferably in an amount of from 0.15% to 0.3%, such as 0.15%, 0.25%, 0.3% by weight, based on the total amount of the component A.

### (d) Polyorganosiloxane Having at Least One Vinyl Group

The component B comprises at least one polyorganosiloxane having at least one vinyl group.

Preferably, the component B can comprise at least two polyorganosiloxanes having at least one vinyl group, preferably a mixture of at least one linear polyorganosiloxane having at least one vinyl group and at least one branched polyorganosiloxane having at least one vinyl group, more preferably a vinyl functional MQ polyorganosiloxane.

Preferably, the polyorganosiloxane having at least one vinyl group is a polydiorganosiloxane, more preferably a polydimethylsiloxane, having at least one, preferably at least two vinyl groups per molecule, more preferably at least two terminal vinyl groups per molecule.

In preferred embodiments, the polyorganosiloxane having at least one vinyl group in a two-component foamable silicone composition can be QM-resin, vinyl-terminated polyorganosiloxane, and a mixture thereof. The vinyl-terminated polyorganosiloxane can have one terminated vinyl group, preferably have two terminated vinyl groups.

In preferred embodiments, the vinyl-terminated polyorganosiloxane can be a mixture comprising at least one vinyl-terminated polyorganosiloxane having viscosity of lower than 20,000 cps at 20° C. and at least one vinyl-terminated polyorganosiloxane having viscosity of from 20,000 to 80,000 cps at 20° C.; more preferably a mixture of at least one vinyl-terminated polyorganosiloxane having viscosity of lower than 10,000 cps at 20° C. and at least one vinyl-terminated polyorganosiloxane having viscosity of from 30,000 to 70,000 cps at 20° C. The vinyl-substitution can range from about 0.0001% to 3% by weight, and preferably from about 0.001% to about 1% by weight, based on the weight of the polyorganosiloxane having at least one vinyl group in the component B.

The vinyl functional groups can be introduced in the polyorganosiloxane via various reactions.

It is possible to use commercially available products in the present invention. Examples thereof include Genesee MSR 8001-1H available from Genesee Advanced Materials Nantong Co., Ltd.

With particular preference, the polyorganosiloxane having at least one vinyl group may be incorporated into the foamable silicone composition in an amount of from 60.2% to 94.9% by weight, preferably from 75% to 85% by weight, such as 75%, 77%, 82%, 84% by weight, based on the total weight of the component B.

### (e) Polyorganosiloxane Having at Least One —SiH Group

The component B comprises at least one polyorganosiloxane having at least one —SiH group.

In preferred embodiments, the polyorganosiloxane having at least one —SiH group can be a polydiorganosiloxane, preferably polydimethylsiloxane, having at least one, preferably at least two —SiH groups, preferably two terminal —SiH groups.

The polyorganosiloxane having at least one —SiH group can be a linear or branched structure incorporated with silicon-bonded hydrogen atoms.

In preferred embodiments, the —SiH group-containing polyorganosiloxane has on average at least two —SiH groups per molecule, more preferably at least five —SiH groups per molecule, even more preferably at least ten —SiH groups per molecule. The silicon-bonded hydrogen groups in the polyorganosiloxane react with the chemical blowing agent, preferably polyorganosiloxane having at least one hydroxyl group, to build the backbone of the silicone foam and generate hydrogen gas to form the bubble structure.

In preferred embodiments, the component B comprises a mixture of at least two polyorganosiloxane having at least one —SiH group, preferably selected from polyorganosiloxanes having at least one —SiH group with the —SiH content of from 0.05 to 5 mmol/g, from 5 to 10 mmol/g, and/or from 10 to 20 mmol/g, based on the weight of the polyorganosiloxane having at least one —SiH group.

In preferred embodiments, the component B comprises a mixture of three polyorganosiloxanes having at least one —SiH group comprising polyorganosiloxanes having at least one —SiH group with the —SiH content of from 0.05 to 5 mmol/g, from 5 to 10 mmol/g and from 10 to 20 mmol/g, based on the total weight of the polyorganosiloxane having at least one —SiH group.

Particularly preferred, the component B comprises a mixture of three polyorganosiloxane having at least one —SiH group comprising polyorganosiloxane having at least one —SiH group with a viscosity at 25° C. of from 50 to 10,000 cps, from 50 to 5000 cps and from 50 to 500 cps.

One embodiment of the present invention preferably uses a mixture of at least two different polyorganosiloxanes having at least one —SiH group selected from polyorganosiloxanes having at least one —SiH group with
(i) on average at least two —SiH groups per molecule, preferably at least five —SiH groups per molecule, more preferably at least ten —SiH groups per molecule, and/or
(ii) a —SiH content of from 0.05 to 5 mmol/g, from 5 to 10 mmol/g, and/or from 10 to 20 mmol/g, based on the total weight of the polyorganosiloxane having at least one —SiH group, and/or
(iii) a viscosity at 25° C. of from 50 to 10,000 cps, from 50 to 5000 cps, and/or from 50 to 500 cps.

It is possible to use commercially available products in the present invention. Examples thereof include Crosslinker 100 available from Evonik Specialty Chemicals (Shanghai).

With particular preference, the polyorganosiloxane having at least one —SiH group may be incorporated into the foamable silicone composition in an amount of from 5% to 29.9% by weight, preferably from 7% to 17.7% by weight, such as 8%, 10%, 13%, 16% by weight, based on the total weight of the component B.

### (f) Expandable Graphite

The component B comprises at least one expandable graphite present in an amount of less than 10% by weight, based on the total weight of the component B.

Preferred in accordance with invention is a two-component foamable silicone composition, wherein the expandable graphite is present in an amount of from 0.1% to 9.9% by weight, preferably from 3% to 8% by weight, more preferably from 3% to 5% by weight, based on the total weight of the component B.

Preferred in accordance with invention is a two-component foamable silicone composition, wherein the expandable graphite has an average particle size of no more than 75 micrometers, preferably from 1 to 70 micrometers, more preferably from 5 to 60 micrometers, and even more preferably from 10 to 50 micrometers.

The average particle size can be measured by sieving method, for example, the expression “average particle size of 75 μm” means that 80% of the particles of the expandable graphite have a particle size of 75 μm and 20% of the particles of the expandable graphite have a particle size of less than 75 μm.

The expandable graphite can be a layered crystal consisting of sheets of carbon atoms tightly bound to each other. Chemicals (such as sulphuric acid for expandable graphite) may be inserted between the carbon layers. When exposed to heat, expandable graphite expands and generates a voluminous insulative layer thus providing fire performance of interest to the polymeric matrix. The expandable graphite can be prepared either by oxidation with a chemical reagent or electrochemically in the intercalating acid (i.e. H₂SO₄, HNO₃, etc.), or made from natural graphite scales by intercalation.

The expandable graphite used in the present invention is not particularly limited, either can be obtained by a chemical reaction or physical way, as long as the objective of flame retardant of the present composition can be obtained.

It is possible to use commercially available products of expandable graphite in the present invention. Examples thereof include ADT 20 having average particle size of 75 μm, ADT 150 having average particle size of 100 μm and ADT 802 having average particle size of from 180 to 200 μm, all available from Shijiazhuang ADT Carbonic Material Factory; alternatively CX 200 having average particle size of 75 μm, CX 325 having average particle size of 50 μm and CX 150 having average particle size of 100 μm, all available from Qingdao Tianheda Graphite Co., Ltd.

The foamable silicone composition of the present invention may contain other additives as long as a flame-retardant silicone foam targeted by the present invention can be obtained, and it is preferred that the additives do not negatively affect the cell structure.

### (g) Additional Filler

In certain embodiments of the present invention, the component A, or B, or both may optionally comprise at least one additional filler other than the expandable graphite. The additional filler is selected from the group consisting of reinforcing and non-reinforcing fillers, such as silica, MQ resin, SiO₂ nanoparticles, fumed silicas, precipitated silicas, calcium carbonate, metal oxide (hydrated alumina, titanium dioxide, magnesium oxide, zinc oxide, iron oxide, chromium oxide, zirconium oxide, aluminum oxide, aluminum hydroxide); pigments (carbon black and organic pigments). Preferably, the average particle size of the additional fillers ranges from 0.1 to 50 micrometers.

The additional fillers are those commonly used for preparing a silicone foam and are not particular limited as long as the silicone foam targeted by the present invention can be obtained. In a preferred embodiment, the additional filler is fumed silicas, and examples thereof include AEROSIL® R 974 available from Evonik Specialty Chemicals (Shanghai) Co, Ltd, Silopren LSR Color Paste (black) available from Momentive Performance Materials GmbH.

An excellent balance of properties, as described above, of the foamable silicone composition and the silicone foam can be achieved when fumed silicas, preferably fumed silicas are used as the filler additional to the expandable graphite in the foamable silicone composition.

Preferred in accordance with the invention is a two-component foamable silicone composition wherein the amount of the additional filler(s) is from 2% to 40% by weight, preferably 10% to 30% by weight, such as 10%, 12%, 14%, 16%, 18%, 20%, 22%, 24%, 26%, 28% by weight, each based on the total weight of composition A or component B.

### (h) Inhibitor

In certain embodiments of the present invention, the component A may comprise at least one inhibitor, preferably selected from tetravinyltetramethylcyclotetrasiloxane (vinyl D4), ethynylcyclohexanol (ECH) and mixtures thereof.

In order to prolong the creaming time to ensure the sealing performance without significantly prolonging the curing time, the ratio of by weight of catalyst to inhibitor is preferably from 3.5:1 to 4.5:1.

It is possible to use commercially available products in the present invention. Examples thereof include Inhibitors MVC and DVS available from Evonik Nutrition & Care GmbH.

Preferred in accordance with the invention is a two-component foamable silicone composition wherein the amount of the inhibitor is from 0.06% to 0.6% by weight, preferably 0.12% to 0.2% by weight, such as 0.12%, 0.14%, 0.16%, 0.18% by weight, based on the total weight of the composition A.

Preferred in accordance with the invention is a two-component foamable silicone composition, wherein the component A and the component B can be mixed in a ratio by weight of ranging from 1.5:1 to 1:1.5, preferably from 1.2:1 to 1:1.2, and more preferably 1:1.

Particularly preferred is a two-component foamable silicone composition, wherein the ratio of the number of moles of —SiH groups of the polyorganosiloxane having at least one —SiH group in the component B to the number of moles of —OH groups of the chemical blowing agent in the component A is from 1:1 to 10:1, more preferably from 2:1 to 8:1, even more preferably from 3:1 to 5:1. This serves to ensure an excellent cell structure and a low density of the silicone foam.

Preferred in accordance with the invention is a two-component foamable silicone composition comprising the component A with a viscosity of from 160,000 to 200,000 cps at 20° C.; and the component B with a viscosity of from 160,000 to 200,000 cps at 20° C., resulting in a high compression rate as well as an excellent cell structure.

A further aspect of the present invention relates to a method for preparing a foam attached to a part of assembly in situ, comprising the following steps:
I. preparing a two-component foamable silicone composition of the invention;
II. mixing the component A and component B at a reaction temperature from 15 to 100° C., preferably from 20 to 80° C., to form a reaction mixture; and
III. applying the reaction mixture to at least one surface of a part.

In the step II above, the components A and B can be mixed by dynamic mixing at 2000 to 3000 rpm.

A further aspect in connection with the present invention relates to the silicone foam obtained by said method.

A further aspect in connection with the present invention relates to the use of a two-component foamable silicone composition or the silicone foam of the invention in gasket, sealant, or adhesive.

Preferred in accordance with the invention is the use of the embodiments identified earlier on above as being preferred or more preferred, for the two-component foamable silicone composition of the invention or for silicone foam of the invention, where preferably two or more of the aspects or corresponding features described for the two-component foamable silicone composition or for the silicone foam are combined with one another.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

Genesee MSR 8001-1H is silicone QM resin in white powder and flakes. The resin is solvent free totally, without organic solvents such as xylene, isopropane, etc. It is available from Genesee Advanced Materials Nantong Co., Ltd.

Andisil® VS 10,000 is vinyl-terminated dimethylpolysiloxanes having viscosity, at 20° C., of lower than 10000 cps. It is available from AB Specialty Silicones LLC.

Andisil® VS 65,000 is vinyl-terminated dimethylpolysiloxanes having viscosity, at 20° C., of 65,000 cps. It is available from AB Specialty Silicones LLC.

Crosslinker 100 is a polydimethylsiloxane having 7.8 mmol/g —SiH groups in the polymer chain and having viscosity at 25° C., of 45 cps. It is available from Evonik Specialty Chemicals (Shanghai).

Andisil® OH Polymers is a mixture comprising Andisil® OH 70 with viscosity at 25° C., of 70 cps Andisil® OH 750 with viscosity at 25° C., of 750 cps and Andisil® OH 4000 with viscosity at 25° C., of 4000 cps, wherein the mixing ratio by weight of Andisil® OH 70, Andisil® OH 750 and Andisil® OH 4000 is 2:2:1. They are available from AB Specialty Silicones, LLC.

Catalyst 510 is platinum catalyst with viscosity at 25° C. of 400 cps. It is available from Evonik Specialty Chemicals (Shanghai).

AEROSIL® R 974 is a hydrophobic fumed silica after treated with dimethyldichlorosilane based on a hydrophilic fumed silica with a specific surface area of 150-200 m²/g. It is available from Evonik Specialty Chemicals (Shanghai) Co, Ltd.

130-913058 from Bomex Berlac Group is a polydimethylsiloxane containing vinyl groups with colored pigment, with the viscosity of 567 to 1053 cps.

Exolit® OP 945 is a white fine-grained powder based on an organic phosphinate with a D95 of less than 5 μm. It is available from Clariant Plastics & Coatings (Deutschland) GmbH.

MARTINAL® ON-908 is an aluminum hydroxide flame retardant filler with particle size of 8 μm. It is available from Huber Engineered Materials.

CX 325 manufactured by Qingdao Tianheda Graphite Co., Ltd. is expandable graphite having average particle size of 50 μm.

ADT 20 manufactured by Shijiazhuang ADT Carbonic Material Factory is expandable graphite having average particle size of 75 μm.

ADT 150 manufactured by Shijiazhuang ADT Carbonic Material Factory is expandable graphite having average particle size of 100 μm.

ADT 802 manufactured by Shijiazhuang ADT Carbonic Material Factory is expandable graphite having average particle size of 200 μm.

Inhibitor MVC is a pure silicone-based inhibitor which controls the activity of the catalyst, with the low viscosity of 4 cps at 25° C. It is available form Evonik Nutrition & Care GmbH.

### Test Methods:

### Flame-Retardancy:

The flame-retardant property of the foamable silicone composition was determined according to UL 94: Test for Flammability of Plastic Materials for Parts in Devices and Appliances. Passing Level V0 of UL 94 can be considered to have excellent flame-retardancy. Specifically, after two 10-second combustion tests on the sample, the flame extinguishes within 10 seconds and no burning material can fall off.

### Viscosity:

The viscosity of components A and B was tested by Brookfield digital viscometer BF, using spindle 7, at 5 rpm according to EN ISO 2555.

### Density:

The density of components A and B was determined according to ASTM D 1475.

The density of the gasket was determined according to ASTM D3574-77.

If the silicone foam gasket has a density of from 400 to 500 g/cm³, it will be considered as acceptable during use.

### Compression Rate:

The compression rate of silicone foam gasket in the sealing application was measured by pressing the gasket during the sealing test. Generally, for the sealing application, the compression rate of the silicone gasket should be controlled at 30% to 50% considering the substrate flatness and compression stress. For example, the gasket normally can be pressed to 2.5 to 3.5 mm if the original gasket height is 5 mm during the sealing test.

The silicone foam gasket having compression rate greater than 30% can be considered to have better performance than most of commercial products in the market.

### Sealing Performance:

The aging condition is 85° C. and 85% humidity for 1000 hours' aging under the 50% compression rate. After aging, pressure was released. The original height of silicone foam gasket and the height of the same after testing was recorded after 1 hour and the CS value was calculated as follows:

CS value=[(t₀−t₁)/t₀]*100

where CS is compression set, to is original height, tᵢ is the height after testing.

The CS value greater than 20% can be considered as unacceptable during use.

### Dispensing Continuity

The dispensing continuity of the silicone foam gasket according to the present invention (Example 1 to 5) and Comparative Examples 1 to 7 were tested and evaluated according to the method consisting of the following steps:

1. The examples and comparative examples of silicone foam were dispensed by equipment through dynamic mixing, respectively. For each sample, the silicone foam gaskets had the same height through tuning the parameter of dispensing machine, such as mixing speed, dispensing speed etc.;
2. After confirmed the parameters, the examples were dispensed continuously until the mixing head required cleaning;
3. Recorded each sample's frequency of cleaning to evaluate the dispensing continuity; and
4. Evaluated the dispensing continuity by the following scales:

| The frequency of cleaning | Scale |
|---|---|
| 12 h to 24 h | Excellent dispensing continuity |
| 6 h to less than 12 h | Good dispensing continuity |
| 4 h to less than 6 h | Fair dispensing continuity |
| Less than 4 h | Poor dispensing continuity |

### Cell Structure

The cell structures of gasket were magnified by optical microscope Nikon Eclipse LV100ND. The test and evaluation accords to the following steps:

1. Prepared the cross section of each silicone foam gasket;
2. Magnified and observed the cell structure using optical microscope; and
3. Evaluated the cell structure by the following scales:

| Description | Scale |
|---|---|
| Ample foams in a homogenized distribution | Excellent |
| Ample foams in a not homogenized distribution | Good |
| No foam or scattered foams in a not homogenized | Poor |
| distribution | |

### Examples (Ex.) 1 to 5 and Comparative Examples (CE.) 1 to 7

The silicone foam gasket was formed by mixing the component A and component B in amounts (wt. % by weight) listed in the Table 1 at a room temperature with the mixing ratio of 1:1 and dispensed by equipment with a dynamic mixer. The properties were tested using the methods stated above, and the results of evaluations were shown in Tables 2 to 7.

TABLE 1

| Ingredients | CE. 1 | CE. 2 | CE. 3 | CE. 4 | CE. 5 | CE. 6 | CE. 7 |
|---|---|---|---|---|---|---|---|
| Component A | | | | | | | |
| Genesee MSR 8001-1H | 13.51 | 13.46 | 13.51 | 13.51 | 13.51 | 13.51 | 13.51 |
| Andisil ® VS 10,000 | 31.7 | 31.7 | 31.7 | 31.7 | 31.7 | 31.7 | 31.7 |
| Andisil ® VS 65,000 | 17.8 | 17.3 | 15.3 | 15.3 | 15.3 | 17.8 | 17.8 |
| Andisil ® OH Polymers | 31 | 31 | 33.5 | 33.5 | 33.5 | 31 | 31 |
| Catalyst 510 | 0.4 | 0.95 | 0.4 | 0.4 | 0.4 | 0.4 | 0.4 |
| AEROSIL ® R 974 | 0.09 | — | 0.09 | 0.09 | 0.09 | 0.09 | 0.09 |
| Inhibitor MVC | 5.5 | 5.5 | 5.5 | 5.5 | 5.5 | 5.5 | 5.5 |
| Component B | | | | | | | |
| Genesee MSR 8001-1H | 33 | 30.6 | 27 | 25 | 25 | 30 | 29 |
| Andisil ® VS 10,000 | 30.3 | 28.8 | 30 | 27.5 | 27.5 | 26 | 25 |
| Andisil ® VS 65,000 | 17 | 16.16 | 18 | 16 | 16 | 17 | 16.56 |
| Crosslinker 100 | 14.14 | 14.14 | 17 | 16.5 | 16.5 | 15 | 14.14 |
| 130-9I3058 | 5.56 | 5.3 | 5 | 5 | 5 | 5 | 5.3 |
| Exolit ® OP 945 | — | 5 | — | — | — | — | — |
| MARTINAL ON-908 | — | — | 3 | 10 | 10 | 4 | — |
| CX 325 | — | — | — | — | — | — | 10 |

| Ingredients | Ex. 1 | Ex. 2 | Ex. 3 | Ex. 4 | Ex. 5 |
|---|---|---|---|---|---|
| Component A | | | | | |
| Genesee MSR 8001-1H | 13.51 | 13.51 | 13.51 | 13.51 | 13.51 |
| Andisil ® VS 10,000 | 31.7 | 31.7 | 31.7 | 31.7 | 31.7 |
| Andisil ® VS 65,000 | 17.8 | 17.8 | 17.8 | 18.8 | 18.8 |
| Andisil ® OH Polymer | 31 | 31 | 31 | 30 | 30 |
| Catalyst 510 | 0.4 | 0.4 | 0.4 | 0.4 | 0.4 |
| AEROSIL ® R 974 | 0.09 | 0.09 | 0.09 | 0.09 | 0.09 |
| Inhibitor MVC | 5.5 | 5.5 | 5.5 | 5.5 | 5.5 |
| Component B | | | | | |
| Genesee MSR 8001-1H | 31.06 | 30.6 | 30.6 | 30.6 | 30.6 |
| Andisil ® VS 10,000 | 29.26 | 28.8 | 28.8 | 28.8 | 28.8 |
| Andisil ® VS 65,000 | 16.4 | 16.16 | 16.16 | 17.5 | 17.5 |
| Crosslinker 100 | 14.35 | 14.14 | 14.14 | 12.8 | 14.8 |
| 130-9I3058 | 5.38 | 5.3 | 5.3 | 5.3 | 5.3 |
| CX 325 | 3.55 | 5 | — | — | — |
| ADT 20 | — | — | 5 | — | — |
| ADT 150 | — | — | — | 5 | — |
| ADT 802 | — | — | — | — | 3 |

TABLE 2
Flame retardancy

| CE. 1 | CE. 2 | CE. 3 | CE. 4 | CE. 5 | CE. 6 | CE. 7 | Ex. 1 | Ex. 2 | Ex. 3 | Ex. 4 | Ex. 5 |
|---|---|---|---|---|---|---|---|---|---|---|---|
| fail | fail | fail | pass | pass | pass | pass | pass | pass | pass | pass | pass |

TABLE 3
Compression rate

| CE. 1 | CE. 3 | CE. 4 | CE. 5 | CE. 6 | CE. 7 | Ex. 1 | Ex. 2 | Ex. 3 | Ex. 4 | Ex. 5 |
|---|---|---|---|---|---|---|---|---|---|---|
| 50% | 50% | 50% | 50% | 50% | 50% | 50% | 50% | 50% | 50% | 50% |

TABLE 4
Compression set

| CE. 1 | CE. 3 | CE. 4 | CE. 5 | CE. 6 | CE. 7 | Ex. 1 | Ex. 2 | Ex. 3 | Ex. 4 | Ex. 5 |
|---|---|---|---|---|---|---|---|---|---|---|
| 10% | 20% | 25% | 25% | 25% | 15% | 10% | 15% | 15% | 15% | 15% |

TABLE 5
Gasket density (g/cm³)

| CE. | CE. | CE. | CE. | CE. | CE. | Ex. | Ex. | Ex. | Ex. | Ex. |
|---|---|---|---|---|---|---|---|---|---|---|
| 1 | 3 | 4 | 5 | 6 | 7 | 1 | 2 | 3 | 4 | 5 |
| 400 | 500 | 550 | 620 | 650 | 470 | 430 | 450 | 450 | 470 | 450 |

TABLE 6
Dispensing continuity

| CE. 1 | CE. 3 | CE. 4 | CE. 5 | CE. 6 | CE. 7 | Ex. 1 | Ex. 2 | Ex. 3 |
|---|---|---|---|---|---|---|---|---|
| Excellent | Fair | Fair | Poor | Good | Fair | Excellent | Excellent | Good |

TABLE 7
Cell structure

| CE. 1 | CE. 3 | CE. 4 | CE. 5 | CE. 6 | CE. 7 | Ex. 1 | Ex. 2 | Ex. 3 | Ex. 4 | Ex. 5 |
|---|---|---|---|---|---|---|---|---|---|---|
| Excellent | Good | Poor | Poor | Poor | Poor | Excellent | Excellent | Excellent | Good | Good |

As can be seen from Tables 2 to Table 7, the silicone foams of the present invention passed Level V0 of flame-retardancy test (UL-94) and showed good compression rate, good sealing performance-compression set, low gasket density, excellent dispensing continuity and excellent cell structure.

Comparative examples 1 to 7 (CE.1 to CE.7), in which the expandable graphite was not used (CE.1 to CE. 6) or used in 10% by weight based on total weight of component B (CE.7), all showed one or more unsatisfied properties compared with the silicone foam of the present invention, or even could not cure and form for further testing (CE.2).

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A two-component foamable silicone composition comprising:
a component A comprising
(a) at least one polyorganosiloxane having at least one vinyl group,
(b) at least one chemical blowing agent, and
(c) at least one catalyst; and
a component B comprising
(d) at least one polyorganosiloxane having at least one vinyl group,
(e) at least one polyorganosiloxane having at least one —SiH group, and
(f) at least one expandable graphite in an amount of less than 10% by weight, based on the total weight of the component B.

2. The composition according to claim 1, wherein the components A and B independently comprise a mixture of at least one linear polyorganosiloxane having at least one vinyl group and at least one branched polyorganosiloxane having at least one vinyl group.

3. The composition according to claim 1, wherein the (a) and/or (d) polyorganosiloxane having at least one vinyl group is a polydimethylsiloxane, having at least two vinyl groups per molecule.

4. The composition according to claim 1, wherein the (a) and/or (d) polyorganosiloxane having at least one vinyl group is a polydimethylsiloxane, having at least two terminal vinyl groups per molecule.

5. The composition according to claim 1, wherein the chemical blowing agent is selected from water, alcohol, preferably methanol, ethanol, propanol, isopropanol, butanol, polyorganosiloxanes having at least one hydroxyl group and mixtures thereof.

6. The composition according to claim 1, wherein the chemical blowing agent is a polyorganosiloxane having at least one hydroxyl group.

7. The composition according to claim 1, wherein the chemical blowing agent is a polydimethylsiloxane having one hydroxyl group; a polydimethylsiloxane having at least two hydroxyl groups; a polydimethylsiloxane having two terminal hydroxyl groups; and
combinations thereof.

8. The composition according to claim 1, wherein the catalyst is selected from the group consisting of platinum, palladium, rhodium, nickel, iridium, ruthenium catalysts, and mixtures thereof.

9. The composition according to claim 1, wherein the (e) polyorganosiloxane having at least one —SiH group is a polydimethylsiloxane having one —SiH group; a polydimethylsiloxane having at least two —SiH groups; a polydimethylsiloxane having at least two terminal —SiH groups; and combinations thereof.

10. The composition according to claim 1, wherein the component B comprises a mixture of at least two polyorganosiloxanes each having at least one —SiH group and an —SiH content of from 0.05 to 5 mmol/g, based on the total weight of the polyorganosiloxane having at least one —SiH group.

11. The composition according to claim 1, wherein the ratio of moles of —SiH groups of the polyorganosiloxane having at least one —SiH group in the component B to moles of —OH groups of the chemical blowing agent in the component A is from 1:1 to 10:1.

12. The composition according to claim 1, wherein the expandable graphite has an average particle size of no more than 75 micrometers.

13. The composition according to claim 1, wherein the expandable graphite is present in an amount of from 0.1 to 9.9% by weight, based on the total weight of the component B.

14. The composition according to claim 1, wherein at least one of the components A and B further comprises at least one filler and/or at least one inhibitor.

15. Cured reaction products of the two-component foamable silicone composition of claim 1.

16. A gasket, sealant or adhesive comprising the two-component foamable silicone composition according to claim 1.

17. A method for preparing a silicone foam attached to a part of assembly in situ, comprising the steps:
I. providing the two-component foamable silicone composition according to claim 1;
II. mixing the component A and component B at a reaction temperature from 15 to 100° C. to form a reaction mixture; and
III. applying the reaction mixture to at least one surface of the part.

18. A silicone foam obtained by the method according to claim 17.
